(19) United States
(12) Patent Application Publication
(10) Pub. No.: US 2009/0212938 A1
(43) Pub. Date: Aug. 27, 2009

(54) PROBE DEVICE HAVING A CLIP-ON WIRELESS SYSTEM FOR EXTENDING PROBE TIP FUNCTIONALITY

(75) Inventors: Jason A. Swaim, Castle Rock, CO (US); Kenny Johnson, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Palo Alto, CA (US)

(21) Appl. No.: 12/035,741

(22) Filed: Feb. 22, 2008

(51) Int. Cl. H04B 10/22

(52) U.S. Cl. 340/539.1

(57) ABSTRACT

A probe device is provided that has a clip-on wireless device attached thereto for communicating over a wireless communication link with test equipment having a wireless transceiver attached thereto. The clip-on wireless device may have one or more components that provide additional functionality to the probe device over that which is currently available on most probe devices. Such components may include, for example, run/stop buttons, activity indicators, “headlight” LEDs, etc

### TECHNICAL FIELD OF THE INVENTION

The invention relates to electrical probe devices used to measure electrical signals on conductors of a device under test (DUT). More particularly, the invention relates to a clip-on wireless system that is attachable to a probe device.

### BACKGROUND OF THE INVENTION

A variety of probe devices are used to electrically probe a DUT. For example, a differential probe device is a device having two arms, sometimes referred to as “substrates” or “blades”, each of which has an electrically conductive tip secured to the distal end thereof. During testing of a DUT, the tips are placed in contact with respective conductors of the DUT for sensing electrical signals propagating through the conductors of the DUT. The electrical signals sensed by the tips are passed from the tips to other electrical circuits disposed within the probe device housing that condition the sensed electrical signals. The arms are each electrically coupled at their proximal ends to the ends of respective electrical wires, such as coaxial cables. The electrical signals are passed via the cables to test and measurement equipment, such as an oscilloscope or a logic analyzer.

It would be desirable to be able to add various types of functionality to the probe device near the probe tips, but doing so is difficult for a variety of reasons. Probe devices are generally very small in size and the probe device housings have very little space for anything other than the electrical connections and circuitry normally contained within them for performing the primary functions of the probe device. Consequently, any features that require digital signals and/or power supplies generally cannot be added to the probe device.

Some probe device manufacturers have added a very limited amount of additional functionality to the probe devices. For example, a company called LeCroy Corporation headquartered in Chestnut Ridge, N.Y. has added a colored light emitting diode (LED) to the probe device that illuminates in the color of the channel when the probe device is plugged in to the test equipment. However, adding this and other types of functionality to an existing probe device is difficult due to the nature of the electrical connections in the probe device.

Accordingly, a need exists for a way to provide probe devices with additional features or functionality that does not require the incorporation of additional circuitry, electrical connections or power supplies within the probe device housing.

### SUMMARY OF THE INVENTION

In accordance with the invention, a probe device for use in measuring electrical signals on a DUT is provided that comprises a probe device housing, circuitry disposed within the housing, and a clip-on wireless device secured to the probe device housing. The clip-on wireless device includes a wireless transceiver, a power supply and at least a first component for providing the probe device with additional functionality.

In accordance with another embodiment, the invention provides a clip-on wireless device for use with a probe device. The clip-on wireless device is configured to clip onto a housing of a probe device. The clip-on wireless device comprises a clip body, a power supply on or in the clip body, at least a first component on or in the clip body, and a wireless transceiver on or in the clip body. The first component provides the probe device with additional functionality.

In accordance with another embodiment, the invention provides a method for providing a wireless communication link between a probe device and test equipment. The method comprises equipping a probe device with a clip-on wireless device that includes at least a wireless transceiver, a power supply and at least one functional component that provides additional functionality to the probe device, equipping test equipment with a wireless transceiver, receiving one or more wireless signals in the wireless transceiver of the clip-on wireless device from the wireless transceiver of the test equipment, and causing the at least one functional component to be activated or deactivated based on the received wireless signal.

In accordance with another embodiment, the invention provides a method for providing a wireless communication link between a probe device and test equipment. The method comprises equipping a probe device with a clip-on wireless device that includes at least a wireless transceiver, a power supply and at least one functional component that provides additional functionality to the probe device, equipping test equipment with a wireless transceiver, and transmitting one or more wireless signals from the wireless transceiver of the clip-on wireless device to the wireless transceiver of the test equipment that provide an indication that the at least one functional component has been activated or deactivated.

These and other features and advantages of the invention will become apparent from the following description, drawings and claims.

### BRIEF DESCRIPTION OF THE DRAWINGS

FIG. 1 illustrates a top perspective view of the probe device of the invention in accordance with an illustrative embodiment, wherein the probe device includes a clip-on wireless device.

FIG. 2 illustrates a perspective view of the clip-on wireless device shown in FIG. 1.

FIG. 3 illustrates a perspective view of a Universal Serial Bus (USB) wireless transceiver that is designed to plug into a USB port of test equipment, and which is configurable to receive wireless RF signals transmitted by and transmit wireless signals to the clip-on wireless device shown in FIG. 2.

FIG. 4 illustrates a block diagram of the system of the invention in accordance with an illustrative embodiment comprising the probe device shown in FIG. 1 and test equipment.

FIG. 5 illustrates a block diagram of the circuitry of the clip-on wireless device shown in FIGS. 1, 2 and 4 in accordance with an illustrative embodiment.

FIG. 6 illustrates a block diagram of the circuitry of the USB wireless transceiver shown in FIGS. 3 and 4 in accordance with an illustrative embodiment.

FIG. 7 illustrates a flowchart that represents the method in accordance with an illustrative embodiment for providing a wireless communication link between a probe device and test equipment.

FIG. 8 illustrates a flowchart that represents the method in accordance with another illustrative embodiment for providing a wireless communication link between a probe device and test equipment.

### DETAILED DESCRIPTION OF ILLUSTRATIVE EMBODIMENTS

In accordance with the invention, a probe device is provided that has a clip-on wireless device attached thereto for communicating over a wireless communication link with a wireless transceiver connected to test equipment. In accordance with an embodiment, the clip-on wireless device includes one or more components that provide additional functionality to the probe device over that which is currently available on probe devices. Such components may include, for example, run/stop buttons, activity indicators, “headlight” LEDs, a power saving mode circuit, etc.

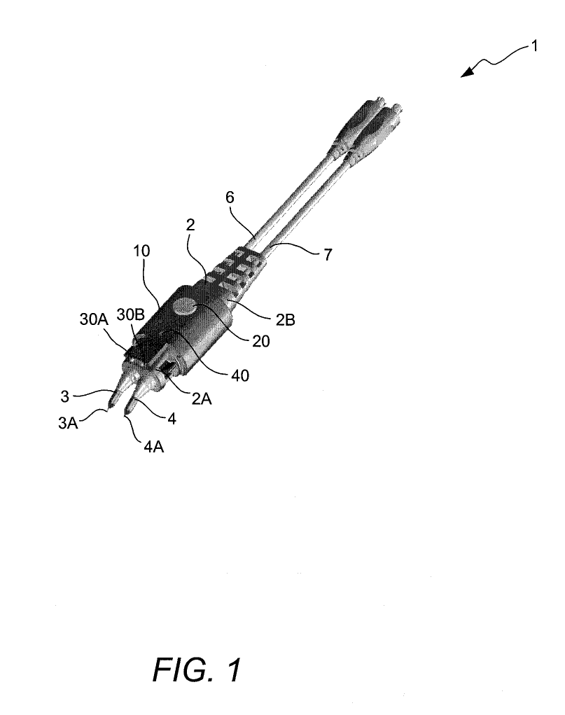

FIG. 1 illustrates a top perspective view of an electrical probe device 1 equipped with a clip-on wireless device 10 in accordance with an illustrative embodiment of the invention. It should be noted that the invention is not limited with respect to the type or configuration of the probe device with which the clip-on wireless device of the invention is used. For illustrative purposes, the probe device with which the clip-on wireless device 10 is used is described herein as being a differential probe device. The invention, however, is equally suited for use with probe devices that are not differential probe devices, as will be understood by persons of ordinary skill in the art in view of the description being provided herein.

The probe device 1 has a housing 2 that houses the electrical circuitry of the probe device 1. The probe device 1 has two arms 3 and 4, each of which has a conductive tip 3A and 4A, respectively, disposed on the distal end thereof. The proximal ends of the arms 3 and 4 are mechanically coupled to the distal end 2A of the housing 2. The proximal end 2B of the housing 2 is connected to electrical cables 6 and 7, such as coaxial cables, for example. The electrical signals measured by the probe tips 3A and 4A are typically conditioned by electrical circuitry (not shown) contained within the housing 2 and then transmitted along cables 6 and 7 to the equipment (not shown) with which the probe device 1 is used. Because the probe device 1 may be used with various types of measurement and testing equipment, the equipment with which the probe device 1 is used will be referred to hereinafter for illustrative purposes as “the test equipment”. It will be understood, however, that the invention is not limited with respect to the equipment with which the probe device is used.

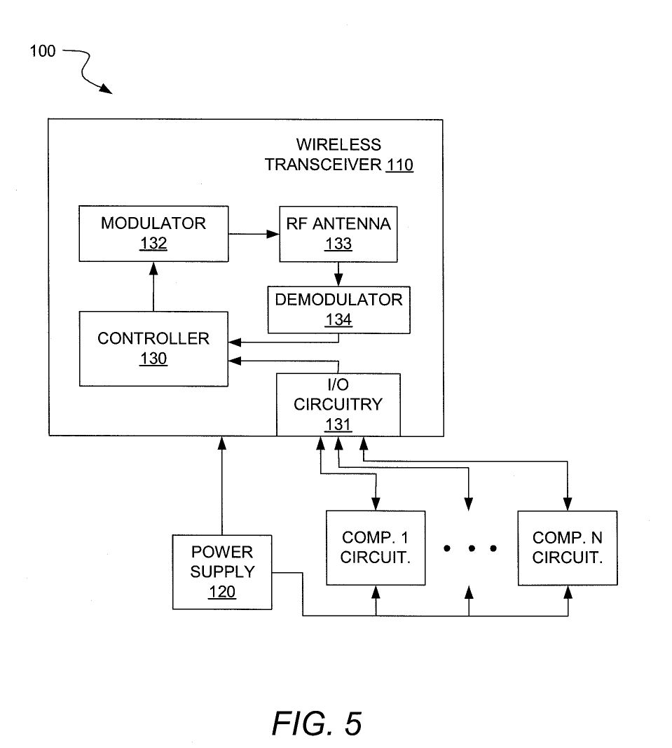

The clip-on wireless device 10 preferably includes a wireless transceiver (not shown), a power supply (not shown), and one or more components 20, 30A, 30B and 40 for providing the probe device 1 with additional functionality. The components 20, 30A, 30B, and 40 are powered by the power supply of the clip-on device 10, as will be described below in more detail with reference to FIG. 5. For example, component 20 represents a multi-colored LED that is illuminated in a particular color when the waveform corresponding to the probe device 1 is displayed on the display screen of the test equipment. Alternatively, multiple mono-colored LEDs that each display a different respective color when illuminated may be included on the clip-on wireless device 10. Typical test equipment apparatuses are equipped to display waveforms corresponding to multiple respective probe devices. Thus, for each probe device connected to the test equipment, the test equipment has a corresponding channel and is capable of displaying the waveform corresponding to that channel. For each channel, the corresponding waveform is typically displayed in a color that is associated with that channel. For example, for a four-channel scope apparatus of test equipment, the four respective waveforms may be displayed in the colors red, green, blue, and yellow, respectively.

In accordance with an illustrative embodiment, the wireless transceiver connected to the test equipment transmits a wireless signal containing an indication of the channel that is currently being displayed on the display screen of the test equipment. The wireless transceiver of the clip-on wireless device 10 receives and decodes the wireless signal and causes the multi-colored LED 20 on the clip-on wireless device 10 to be illuminated in the color corresponding to the waveform currently being displayed. In the case where multiple mono-colored LEDs are included on the clip-on wireless device 10, the wireless transceiver of the clip-on wireless device 10 receives and decodes the wireless signal and causes the corresponding mono-colored LED 20 on the clip-on wireless device 10 to be illuminated.

Other components that may be included on the clip-on wireless device 10 are, for example, run/stop buttons, activity indicators, “headlight” LEDs, etc. For example, components 30A and 30B may correspond to “headlight” LEDs positioned near the probe tips 3A and 4A that illuminate the tips 3A and 4A and the corresponding contact areas on the DUT to help the user better see the tips 3A and 4A on the corresponding contact areas of the DUT as the user is attempting to place the tips in contact with the contact areas on the DUT. As another example, a button 40 may be included on the wireless device 10 to allow the user to run and stop functions being performed by the test equipment on the corresponding channel by actuating the button 40. For example, if the user wants the test equipment to perform a “run signal acquisition” function, the user actuates the button 40 by depressing it, which causes the wireless transceiver of the clip-on device 10 to transmit a wireless signal over the wireless communication link to the wireless transceiver connected to the test equipment. Other buttons, switches and lights (not shown) may be included on the clip-on wireless device 10 to provide additional features and functionality for the probe device 1.

In addition, the clip-on wireless device may include functional components that do not need to be activated/deactivated by the user and that provide no visual indication of any kind to the user. For example, the clip-on wireless device 10 may include a power saving functional component that senses when the user has not contacted or interacted with the probe device 1 within a particular user-selectable amount of time. In this case, the functional component includes either an accelerometer (not shown) or a resistive or capacitive sensor (not shown). The wireless device 10 measures the signal output from the component and sends a corresponding wireless signal to the wireless transceiver connected to the test equipment. The wireless transceiver connected to the test equipment then outputs a signal to circuitry of the test equipment. A processor of the test equipment processes the signal and determines whether or not the signal indicates that the user is interacting with the probe device 1. If the processor of the test equipment determines that the user is not interacting with the probe device 1, the processor then determines how long it has been since the user interacted with the probe device 1. If the processor determines that the user has not interacted with the probe device 10 for a time period greater than the user-selected amount of time, then the processor of the test equipment causes the wireless transceiver connected to the test equipment to send a corresponding wireless signal to the clip-on wireless device 10. The clip-on wireless device 10 then receives the signal and causes the power supply of the wireless device 10 to be turned off or placed in some other power-saving mode.

When the clip-on wireless device 10 is in the power saving mode, if the wireless signal transmitted from the clip-on wireless device 10 to the wireless transceiver connected to the test equipment indicates that the user is interacting with the probe device 1, the processor of the test equipment causes the wireless transceiver connected thereto to send a wireless signal to the clip-on wireless device 10 that causes it to turn the power supply back on, or to exit the power saving mode, so that power is supplied to the functional components of the clip-on wireless device 10.

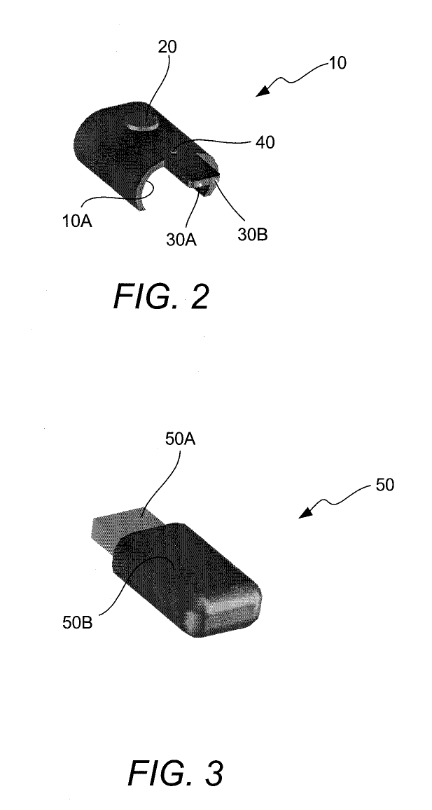

FIG. 2 illustrates a perspective view of the clip-on wireless device 10 shown in FIG. 1. The clip-on wireless device 10 is not limited to having any particular configuration, shape or design. In accordance with this embodiment, the clip-on wireless device 10 has a clip body that has an inner surface 10A that is shaped and sized to clip to the outer surface of the probe device 1 shown in FIG. 1. The clip-on wireless device 10 preferably is removably attachable to the probe device 1 so that it can be easily placed on and removed from the probe device 1. Thus, a single clip-on wireless device 10 may be used with multiple probe devices.

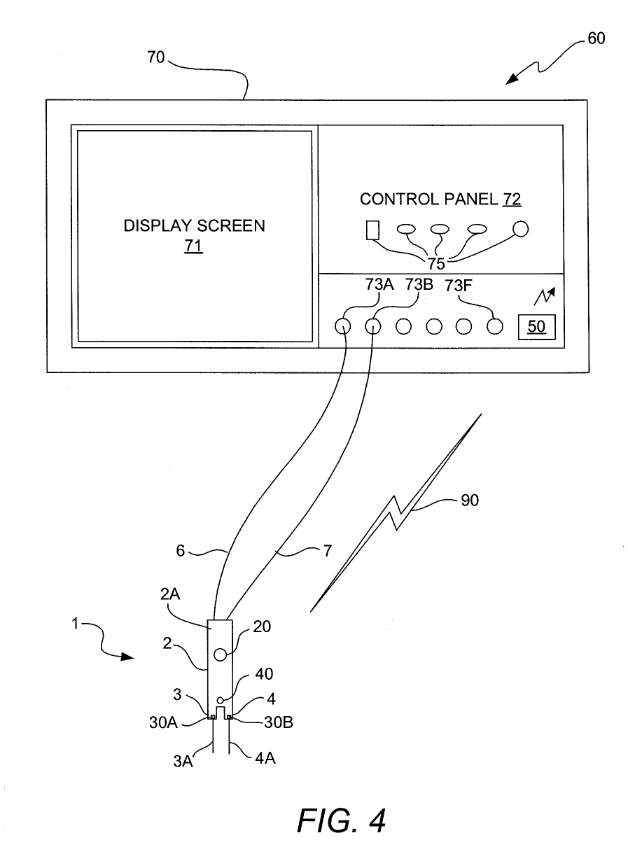

FIG. 3 illustrates a perspective view of a Universal Serial Bus (USB) wireless transceiver 50 that is designed to plug into a USB port of the test equipment, as will be described below in more detail with reference to FIG. 4. The USB transceiver 50 is configured to receive electrical wireless signals transmitted by the clip-on wireless device 10 shown in FIG. 2 and to transmit wireless signals to the clip-on wireless device 10. The portion 50A of the USB wireless transceiver 50 is a USB connector adapted to plug into a USB receptacle, or port, of the test equipment. The portion 50B of the transceiver 50 is the housing of the transceiver 50, which contains USB input/output (I/O) circuitry, wireless transceiver circuitry and controller circuitry.

In accordance with an illustrative embodiment, the USB wireless transceiver 50 is capable of communicating simultaneously with multiple clip-on wireless devices 10. For example, in accordance with an embodiment, the USB wireless transceiver 50 is configured to communicate simultaneously with four clip-on wireless devices 10, which may correspond to, for example, test equipment having four scope channels. The USB wireless transceiver 50 sends wireless signals to the clip-on wireless devices 10 that inform the clip-on wireless devices 10 of the respective channel colors. The wireless transceivers of the clip-on wireless devices 10 receive these signals and cause the LEDs 20 (FIG. 2) to illuminate in the color that matches the waveform being displayed on the display screen of the test equipment for the corresponding channel. As is typical with wireless transceivers, each of the wireless transceivers of the clip-on wireless devices 10 preferably has a unique identifier that is included in wireless signals transmitted between the clip-on wireless devices 10 and the USB wireless transceiver 50 to allow the clip-on wireless devices 10 to identify signals transmitted from the USB wireless transceiver 50 that are intended for the clip-on wireless devices 10, and vice versa.

FIG. 4 illustrates a block diagram of the system 60 of the invention in accordance with an illustrative embodiment. The system 60 comprises the probe device 1 shown in FIG. 1 and test equipment 70. The test equipment 70 may be, for example, a known signal analyzer apparatus. The test equipment 70 includes a display screen 71, a control panel 72, input ports 73A-73F, and the USB wireless transceiver 50 shown in FIG. 3. The USB wireless transceiver 50 is connected to a USB port of the test equipment 70 and communicates with the test equipment 70 in the known manner using a USB protocol. The input ports 73A and 73B are connected to ends of the radio frequency (RF) wires 6 and 7 shown in FIG. 1, which may be, for example, coaxial cables. The opposite ends of the RF wires 6 and 7 are connected to the proximal end 2B of the probe device housing 2. Signals sensed by the tips 3A and 4A of the probe device 1 are conditioned by circuitry (not shown) within the probe device 1 and then transmitted over RF wires 6 and 7, respectively, to the test equipment 70.

In the test equipment 70, the sensed signals are received and processed in a known manner in accordance with the test or tests being performed by the test equipment 70. The test equipment 70 then causes waveforms corresponding to the sensed signals to be displayed on the display screen 71. Various selector switches 75 provided on the control panel 72 or buttons (not shown) in Windows™ based menus displayed on the display screen 71 are used by the user to select the manner in which the signals measured by the probe device 100 are processed and displayed on the display screen 71.

In accordance with this embodiment, the test equipment 70 performs one or more algorithms that receive and process data output from and send data to the USB wireless transceiver 50. The algorithms that are performed by the test equipment 70 to process the data output from the USB wireless transceiver 50 are not limited to any particular algorithms, but will depend generally on the functionality and/or components of the clip-on wireless device 10 (FIGS. 1 and 2). One or more of the components on the clip-on wireless device 10 may not communicate information via the wireless transceiver of the device 10 to the wireless transceiver 50 connected to the test equipment, but may simply provide some functionality on the probe device 1 connected to the test equipment 70. For example, in the case where the clip-on wireless device 10 (FIG. 1) includes headlight LEDs 30A and 30B, these LEDs 30A and 30B may simply be activated when the probe device 1 is in use and receive power from the power supply of the clip-on wireless device 10. In this case, it may be unnecessary to transmit any information relating to the LEDs 30A and 30B via the wireless transceiver of the clip-on wireless device 10 to the USB wireless transceiver 50.

On the other hand, one or more other components on the clip-on wireless device 10 typically do communicate information via the wireless transceiver of the device 10 to the wireless transceiver 50 connected to the test equipment 70. For example, in the case where the button 40 is a run/stop button, activation and deactivation of the button 40 represent events that typically are transmitted via the wireless transceiver of the device 10 to the USB wireless transceiver 50 connected to the test equipment 70.

FIG. 5 illustrates a block diagram of the circuitry 100 of the clip-on wireless device 10 shown in FIGS. 1, 2 and 4 in accordance with an illustrative embodiment. In accordance with this embodiment, the circuitry 100 includes a wireless transceiver 110, a power supply 120 and component circuitries 1-N, where N is a positive integer. The component circuitries 1-N represent the circuits of the components on or in the clip-on wireless device 10 that provide additional functionality to the probe device 1, such as, for example, components 20, 30A and 30B and 40 described above with reference to FIGS. 1, 2 and 4. The power supply 120 provides power to the wireless transceiver 100 and to the component circuitries 1-N.

The wireless transceiver 110 includes a controller 130, I/O circuitry 131, modulator circuitry 132, an RF antenna 133, and demodulator circuitry 134. The controller 130 communicates with the component circuitries 1-N via the I/O circuitry 131. The controller 130 outputs electrical signals to the modulator circuitry 132, which then modulates the antenna 133 with the electrical signals to produce wireless RF signals that are transmitted over the air interface between the wireless transceiver 110 and the USB wireless transceiver 50. The wireless RF signals transmitted over the air interface are received by the USB wireless transceiver 50 (FIGS. 3 and 4). For example, in the case where component circuitry 1 corresponds to the run/stop button 40 (FIG. 1), activation of the button causes an electrical signal to be output from the component 1 circuitry, which is received by the I/O circuitry 131. The I/O circuitry 131 receives the electrical signal in an I/O port of the I/O circuitry 131 and conditions the signal for use by the controller 130. For example, the I/O circuitry 131 may include analog-to-digital converter (ADC) circuitry (not shown) that converts the signal received from the component 1 circuitry into a digital signal that is suitable for processing by the controller 130.

When the I/O circuitry 131 sends the corresponding electrical signal to the controller 130, the signal will include an identification of the I/O port number on which the corresponding signal was received in the I/O circuitry 131. The controller 130 will determine, based on the value of the signal and the port number, that the button 40 has been activated. The controller 30 will then cause a corresponding electrical signal to be output to the modulator circuitry 132, which will then modulate the antenna 133 to cause the corresponding wireless RF signals to be transmitted over the air interface. The modulator circuitry 132 typically includes digital-to-analog conversion (DAC) circuitry (not shown) that converts the digital signals output from the controller 130 into analog signals, which are then used by the modulator circuitry 132 to modulate the antenna 133.

When the USB wireless transceiver 50 (FIG. 4) transmits a wireless signal to the wireless transceiver 110, the antenna 133 receives the wireless signal and outputs a corresponding electrical signal to the demodulator circuitry 134. The demodulator circuitry 134 demodulates the received electrical signal and uses ADC circuitry (not shown) to convert the demodulated signal into a digital signal suitable for processing by the controller 130. The controller 130 receives the corresponding digital signal and processes it in accordance with one or more algorithms. The algorithms associated with the receiver side are typically directed to determining whether the received signal is intended for the clip-on wireless device 10, and if so, causing a corresponding electrical signal to be output from the controller 130 to the I/O circuitry 131. The signal output from the controller 130 to the I/O circuitry 131 typically includes a I/O port identifier to enable the I/O circuitry 131 to determine which of the component circuitries 1-N the signal is intended to drive. The I/O circuitry 131 then causes the corresponding component circuitry 1-N to be driven. The I/O circuitry 131 may or may not include DAC circuitry (not shown) for converting digital signals received from the controller 130 into analog signals that are suitable for driving the component circuitries 1-N. DAC circuitry is not needed if the components are capable of being driven by digital signals.

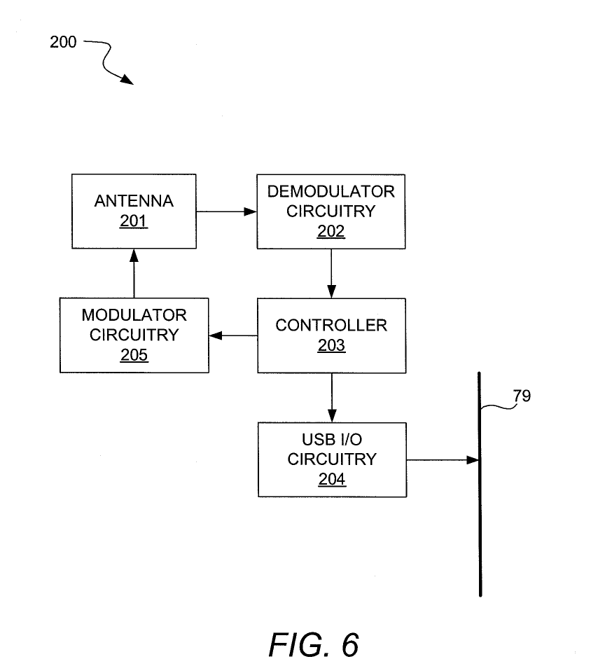

FIG. 6 illustrates a block diagram of the circuitry 200 of the UBS wireless transceiver 50 shown in FIGS. 3 and 4 in accordance with an illustrative embodiment. In general, USB wireless transceivers are known, although it generally is not known to use a USB wireless transceiver for the purpose and in the manner described herein. A variety of USB transceiver configurations are suitable for use with the invention. FIG. 6 represents one example of a USB wireless transceiver configuration that is suitable for use with the invention. The circuitry 200 includes an RF antenna 201, RF demodulator circuitry 202, a controller 203, USB I/O circuitry 204, and RF modulator circuitry 205.

When the USB wireless transceiver 50 is receiving signals, the antenna 201 receives wireless RF signals transmitted by the wireless transceiver 110 shown in FIG. 5 and produces corresponding electrical signals, which are then provided to the demodulator circuitry 202. The demodulator circuitry 202 demodulates the RF signals and converts the demodulated electrical signals into digital signals that are suitable for processing by the controller 203. The demodulator circuitry 202 typically includes ADC circuitry (not shown) for converting the demodulated electrical signals into digital signals that are suitable for processing by the controller 203. The controller 203 processes the digital signals and converts them into USB signals, which are then output to the USB I/O circuitry 204. The USB I/O circuitry 204 then outputs the signals onto a USB bus 79 of the test equipment 70 (FIG. 4), which delivers them to circuitry of the test equipment, such as to a central processing unit (CPU) (not shown) or other processor (not shown) of the test equipment 70.

When the USB wireless transceiver 50 is transmitting signals, the controller 203 processes USB signals received from the USB I/O circuitry 204 to convert them into electrical digital signals suitable for use by the controller 203. The controller 203 outputs the electrical digital signals to the modulator circuitry 205, which then modulates the antenna 201 to produce wireless RF signals. The wireless RF signals are then transmitted over the air interface to the clip-on wireless device 10 (FIGS. 1 and 2). The modulator circuitry 205 typically includes DAC circuitry (not shown) for converting the electrical digital signals received from the controller 203 into analog signals that are suitable for modulating the antenna 201.

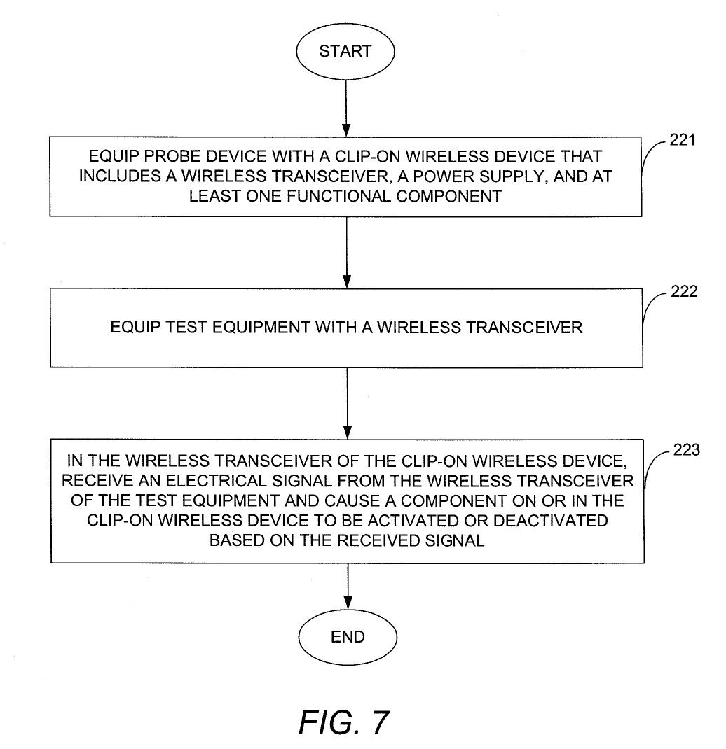

FIG. 7 illustrates a flowchart that represents the method in accordance with an illustrative embodiment of the invention for providing a wireless communications link between a probe device and test equipment. The probe device is equipped with a clip-on wireless device that includes at least a wireless transceiver, a power supply and at least one component that provides functionality to the probe device, as indicated by block 221. The test equipment is equipped with a wireless transceiver, as indicated by block 222. During operations, the wireless transceiver of the clip-on wireless device receives an electrical signal from the wireless transceiver connected to the test equipment and causes at least one functional component of the clip-on wireless device to be activated or deactivated, as indicated by block 223.

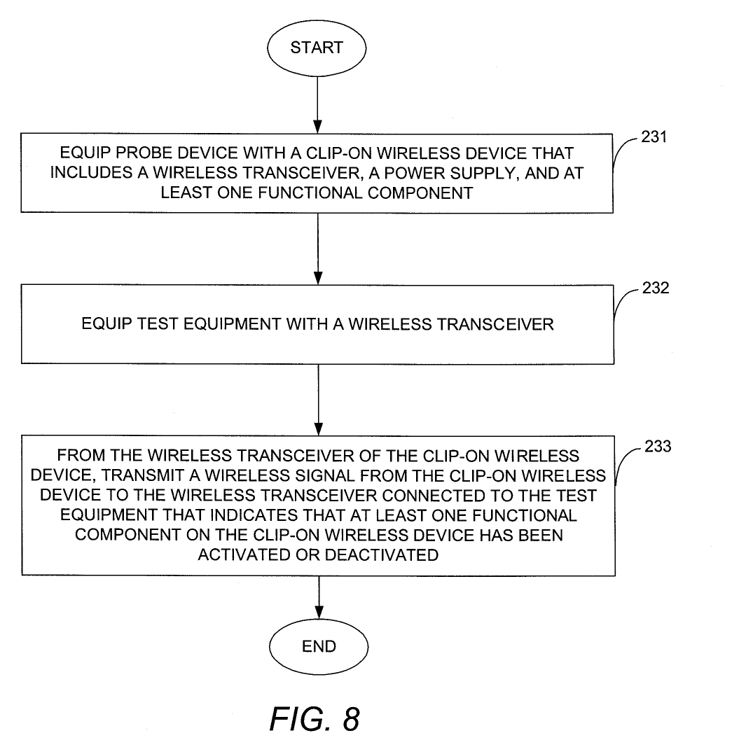

FIG. 8 illustrates a flowchart that represents the method in accordance with another illustrative embodiment of the invention for providing a wireless communications link between a probe device and test equipment. The probe device is equipped with a clip-on wireless device that includes at least a wireless transceiver, a power supply and at least one component that provides functionality to the probe device, as indicated by block 231. The test equipment is equipped with a wireless transceiver, as indicated by block 232. During operations, the wireless transceiver of the clip-on wireless device transmits a wireless RF signal to the wireless transceiver connected to the test equipment that indicates that at least one functional component of the clip-on wireless device has been activated or deactivated, as indicated by block 233.

The controllers 130 (FIG. 5) and 203 (FIG. 6) may be any type of suitable computational devices, including, for example, a microprocessor, a microcontroller, a programmable logic array (PLA), a field programmable gate array (FPGA), an application specific integrated circuit (ASIC), etc. Also, these processing tasks may be performed by a single processor or they may be distributed over multiple processors, as will be understood by persons of ordinary skill in the art in view of the description provided herein. In the event that any of the functions described above are performed in software or firmware executed by the controllers 130 and 203, the corresponding computer code is typically stored in a computer-readable medium, such as, for example, solid state memory within the controllers 130 and 203 or external to the controllers 130 and 203. Other types of computer-readable mediums may also be used for this purpose, such as, for example, magnetic tape, magnetic disks, optical disks, etc. Examples of suitable solid state memory devices include, for example, a random access memory (RAM) device, a read-only memory (ROM) device, a programmable ROM (PROM) device, an erasable PROM (EPROM) device, a flash memory device, etc.

It should be noted that the invention has been described with reference to illustrative embodiments for the purpose of describing the principles and concepts of the invention. For example, although the wireless devices 10 and 50 have both been described as including transceivers, the wireless devices 10 and 50 may instead only include wireless transmitters or wireless receivers. For example, if the clip-on wireless device 10 includes a wireless receiver, but not a wireless transmitter, the wireless device 50 may include only a wireless transmitter. Likewise, if the clip-on wireless device 10 includes a wireless transmitter, but not a wireless receiver, the wireless device 50 may include only a wireless receiver. Thus, the term “transceiver”, as that term is used herein, may denote a device having only a receiver, only a transmitter, or both a receiver and a transmitter. Those skilled in the art will understand, in view of the description provided herein, that many modifications may be made to the embodiments described herein without deviating from the scope of the invention.

What is claimed is:

1. A probe device for use in measuring electrical signals on a device under test (DUT), the probe device comprising:
a probe device housing having a proximal end and a distal end;
probe device circuitry disposed within the probe device housing; and
a clip-on wireless device secured to the probe device housing, the clip-on wireless device including at least a wireless transceiver, a power supply and at least a first component for providing the probe device with additional functionality.

2. The probe device of claim 1, wherein the wireless transceiver is configured to transmit and receive wireless radio frequency (RF) signals over a wireless communication link.

3. The probe device of claim 1, wherein the wireless transceiver is configured to transmit or receive wireless radio frequency (RF) signals over a wireless communication link.

4. The probe device of claim 1, wherein the clip-on wireless device is removably secured to the probe device housing.

5. The probe device of claim 1, wherein the clip-on wireless device has a clip body that has an inner surface that is shaped and sized to clip to the outer surface of the probe device housing.

6. The probe device of claim 1, wherein said at least a first component includes a light source.

7. The probe device of claim 6, wherein the light source is a light emitting diode (LED) capable of being illuminated, the LED emitting an illumination color when the LED is illuminated, the wireless transceiver being configured to receive one or more wireless RF signals over the wireless communication link and to cause the LED to be activated or deactivated based on the received RF signals.

8. The probe device of claim 1, wherein said at least a first component includes a button capable of being actuated and de-actuated, the wireless transceiver being configured to transmit one or more wireless RF signals over the wireless communication link identifying activation or deactivation of the button.

9. The probe device of claim 1, wherein said at least a first component includes at least a first “headlight” light source capable of being illuminated and darkened, the wireless transceiver being configured to receive one or more wireless RF signals over the wireless communication link and to cause the light source to either be illuminated or darkened based on the received wireless RF signals.

10. A clip-on wireless device configured to be clipped onto a housing of a probe device, the clip-on wireless device comprising:
a clip body;
a power supply on or in the clip body;
at least a first component on or in the clip body, said at least a first component providing the probe device with additional functionality; and
a wireless transceiver on or in the clip body.

11. The clip-on wireless device of claim 10, wherein the wireless transceiver is configured to transmit and receive wireless radio frequency (RF) signals over a wireless communication link.

12. The clip-on wireless device of claim 10, wherein the wireless transceiver is configured to transmit or receive wireless radio frequency (RF) signals over a wireless communication link.

13. The clip-on wireless device of claim 10, wherein the clip-on wireless device is removably secured to the probe device housing.

14. The clip-on wireless device of claim 10, wherein the clip-on wireless device has a clip body that has an inner surface that is shaped and sized to clip to the outer surface of the probe device housing.

15. The clip-on wireless device of claim 10, wherein said at least a first component includes a light source.

16. The clip-on wireless device of claim 10, wherein the light source is a light emitting diode (LED) capable of being illuminated, the LED emitting an illumination color when the LED is illuminated, the wireless transceiver being configured to receive one or more wireless RF signals over the wireless communication link and to cause the LED to be activated or deactivated based on the received RF signals.

17. The clip-on wireless device of claim 16, wherein said at least a first component includes a button capable of being actuated and de-actuated, the wireless transceiver being configured to transmit one or more wireless RF signals over the wireless communication link identifying activation or deactivation of the button.

18. The clip-on wireless device of claim 10, wherein said at least a first component includes at least a first “headlight” light source capable of being illuminated and darkened, the wireless transceiver being configured to receive one or more wireless RF signals over the wireless communication link and to cause the light source to either be illuminated or darkened based on the received wireless RF signals.

19. The clip-on wireless device of claim 10, wherein said at least a first component includes at least a power saving mode circuit capable of being activated to place the power supply in a power saving mode of operations and capable of being deactivated to cause the power supply to exit the power saving mode of operations, the wireless transceiver being configured to receive one or more wireless RF signals over the wireless communication link and to cause the power saving mode circuit to be activated or deactivated based on the received wireless RF signals.

20. A method for providing a wireless communication link between a probe device and test equipment, the method comprising:
equipping a probe device with a clip-on wireless device that includes at least a wireless transceiver, a power supply and at least one functional component that provides additional functionality to the probe device;
equipping test equipment with a wireless transceiver; and
in the wireless transceiver of the clip-on wireless device, receiving one or more wireless signals from the wireless transceiver of the test equipment and causing said at least one functional component to be activated or deactivated based on the received wireless signal.

21. A method for providing a wireless communication link between a probe device and test equipment, the method comprising:
equipping a probe device with a clip-on wireless device that includes at least a wireless transceiver, a power supply and at least one functional component that provides additional functionality to the probe device;
equipping test equipment with a wireless transceiver; and
in the wireless transceiver of the clip-on wireless device, transmitting one or more wireless signals to the wireless transceiver of the test equipment, said one or more wireless RF signals providing an indication that said at least one functional component has been activated or deactivated.
